(19) United States
(12) Patent Application Publication
(10) Pub. No.: US 2011/0123783 A1
(43) Pub. Date: May 26, 2011

(54) MULTILAYER BUILD PROCESSSES AND DEVICES THEREOF

(76) Inventor: David Sherrer, Radford, VA (US)

(21) Appl. No.: 12/953,393

(22) Filed: Nov. 23, 2010

Related U.S. Application Data
(60) Provisional application No. 61/263,777, filed on Nov. 23, 2009.

(51) Int. Cl. B32B 38/10; B32B 37/02; C25D 5/02; B32B 3/10

(52) U.S. Cl. 428/195.1; 156/60; 156/247; 205/118; 205/50

(57) ABSTRACT

A process to form devices may include forming a seed layer on and/or over a substrate, modifying a seed layer selectively, forming an image-wise mold layer on and/or over a substrate and/or electrodepositing a first material on and/or over an exposed conductive area. A process may include selectively applying a temporary patterned passivation layer on a conductive substrate, selectively forming an image-wise mold layer on and/or over a substrate, forming a first material on and/or over at least one of the exposed conductive areas and/or removing a temporary patterned passivation layer. A process may include forming a sacrificial image-wise mold layer on a substrate layer, selectively placing one or more first materials in one or more exposed portions of a substrate layer, forming one or more second materials on and/or over a substrate layer and/or removing a portion of a sacrificial image-wise mold layer.

The present application claims priority to U.S. Provisional Patent Application No. 61/263,777 (filed on Nov. 23, 2010), which is hereby incorporated by reference in its entirety.

### BACKGROUND

Embodiments relate to electric, electronic and/or electromagnetic devices, and processes thereof. Some embodiments relate to multilayer build processes, for example to build a multilayer electromagnetic device or a electromagnetic mechanical device.

Processes may not be employed to build a multi-layer structure which employ a plurality of integration processes. Process may not provide for the employment of integration process, for example mid-build of a process flow, to create an end device. Process may not provide the ability to define the in-plane location of two or more materials, which may be non-insulative, in the same layer of a multi-layer structure. Process may not include integration of magnetic materials into a multi-layer build process, for example to fabricate an electromagnetic structure. Processes may not be able to be leveraged in various approaches and/or applications, for example where multiple materials may be integrated hybridly and/or monolithically into a mixed material structure.

Therefore, there may be a need for processes, and devices thereof, which may include one or more of releaseability from a handle wafer, CMOS process compatibility, ability to be produced on a variety of substrate materials, flexible passivation coating options, integration of thin-film and/or solders, interconnection to wafer surface microelectronics, and/or an ability to micromachine a substrate wafer. There may be a need for versatile processes, and/or devices thereof, which may be applicable to magnetic and electro-magnetic MEMS and/or relatively small-scale applications.

### SUMMARY

Embodiments relate to electric, electronic and/or electromagnetic devices, and methods thereof. Some embodiments relate to multilayer build processes, for example to build a multilayer electromagnetic device or a electromagnetic mechanical device. Some embodiments relate to multi-layer build processes including one or more material integration processes, for example including transfer bonding, lamination, pick-and-place, deposition transfer (e.g., slurry transfer), and/or electroplating on and/or over a substrate layer, which may be mid build of a process flow to create an end device.

Embodiments relate to multilayer structures where the in-plane location of two or more materials, which may be non-insulative, may be defined in the same layer of a multi-layer structure. Embodiments relate to integration of magnetic materials into a multi-layer build process, for example to fabricate an electromagnetic structure. In embodiments, multi-layer build processes may be sufficiently general to be leveraged in various approaches and/or applications where multiple materials may be integrated hybridly and/or monolithically into a mixed material structure.

According to embodiments, a process to form a multi-layer structure may include forming a seed layer on and/or over a substrate. In embodiments, a substrate may include one or more layers, which may be an image-wise mold layer. In embodiments, an image-wise mold layer may include one or more materials, for example a conductive and/or insulative material. In embodiments, insulative material may include photoresist and/or dielectric material.

According to embodiments, a process to form a multi-layer structure may include modifying a seed layer. In embodiments, a seed layer may be modified by selectively applying a temporary patterned passivation layer and/or by selectively removing the seed layer. In embodiments, selectively applying a temporary patterned passivation layer may include depositing a layer of passivation material on and/or over a seed layer and patterning the passivation material to expose a portion of the seed layer. In embodiments, an exposed conductive area may be an exposed portion of a seed layer. In embodiments, selectively applying a temporary patterned passivation layer may include selectively placing passivation material on and/or over a seed layer to block a portion of the seed layer. In embodiments, a passivation layer may be substantially thinner relative to the image-wise mold layer.

According to embodiments, selectively removing a seed layer may expose a portion of a substrate, for example a non-conductive portion of a substrate. In embodiments, an exposed conductive area may include the remaining portion of the seed layer.

According to embodiments, a process to form a multi-layer structure may include selectively forming an image-wise mold layer on and/or over a substrate, which may expose one or more conductive area. In embodiments, a process to form a multi-layer structure may electrodepositing a first material on and/or over an exposed conductive area.

According to embodiments, a process to form a multi-layer structure may include removing a temporary patterned passivation layer, providing for example another conducive area. In embodiments, a process to form a multi-layer structure may include forming a second material on the other conductive area. In embodiments, a first material and a second material may be different materials. In embodiments, a first material and/or a second material may be formed by an electrodeposition process, a transfer bonding process, a dispensing process, a lamination process, a vapor deposition process, a screen printing process, a squeegee process, and/or a pick-and-place process. In embodiments, one or more layers and/or materials may be planarized.

According to embodiments, a process to form a multi-layer structure may include selectively applying a temporary patterned passivation layer on a conductive substrate. In embodiments, a process to form a multi-layer structure may include selectively forming an image-wise mold layer on and/or over a substrate, which may expose one or more conductive areas. In embodiments, a process to form a multi-layer structure may include forming a first material on and/or over at least one of the exposed conductive areas. In embodiments, a process to form a multi-layer structure may include removing a temporary patterned passivation layer, which may to provide another conducive area. In embodiments, a process to form a multi-layer structure may include forming a second material on and/or over the other conductive area. In embodiments, a process to form a multi-layer structure may include placing a blocking material on and/or over one or more of exposed conductive areas. In embodiments, blocking material may include ceramic material.

According to embodiments, a process to form a multi-layer structure may include forming a sacrificial image-wise mold layer on a substrate layer, which may exposed one or more portions of a substrate layer. In embodiments, a process to form a multi-layer structure may include selectively placing one or more first materials in one or more exposed portions of a substrate layer. In embodiments, a process to form a multi-layer structure may include forming one or more second materials on and/or over a substrate layer. In embodiments, a process to form a multi-layer structure may include removing a portion of a sacrificial image-wise mold layer.

In embodiments, placing may include any suitable process, including one or more of a transfer bonding process, a dispensing process, a lamination process, and/or a pick-and-place process. In embodiments, one or more layers and/or materials may be planarized. In embodiments, a transfer bonding process may include affixing a first material to a carrier substrate, patterning the material, affixing the patterned material to a substrate, and releasing the carrier substrate

According to embodiments, a lamination process may include patterning a material before and/or after the material is laminated to a substrate layer. In embodiments, a f material may supported by a support lattice to suspend it before it is laminated, and then it may be laminated to a substrate layer. In embodiments, a material may be selectively dispensed. In embodiments, two materials may be spaced apart from each other and/or adjacent each other.

According to embodiments, devices formed by processes in accordance with aspects of embodiments are provided.

### DRAWINGS

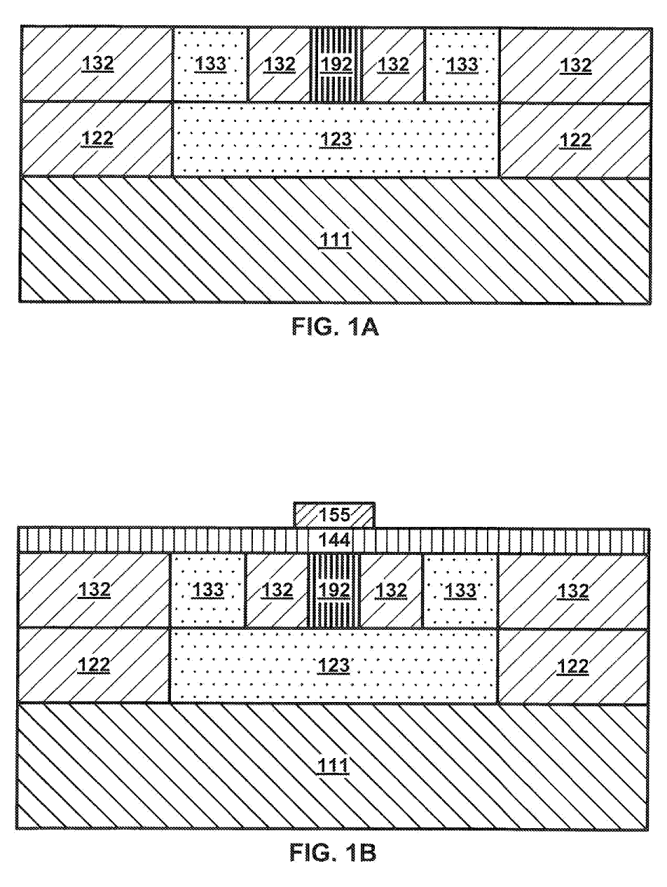

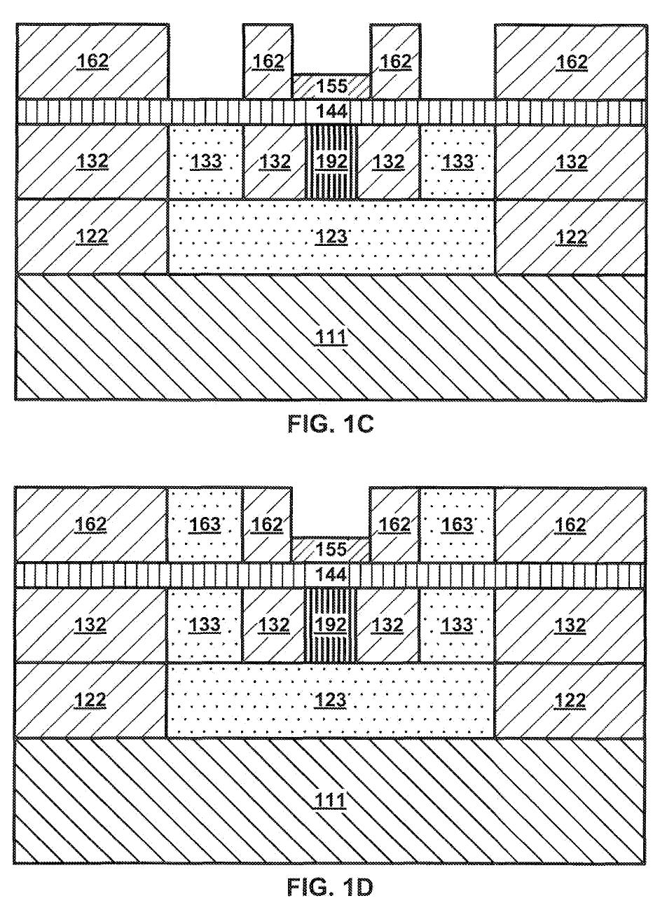

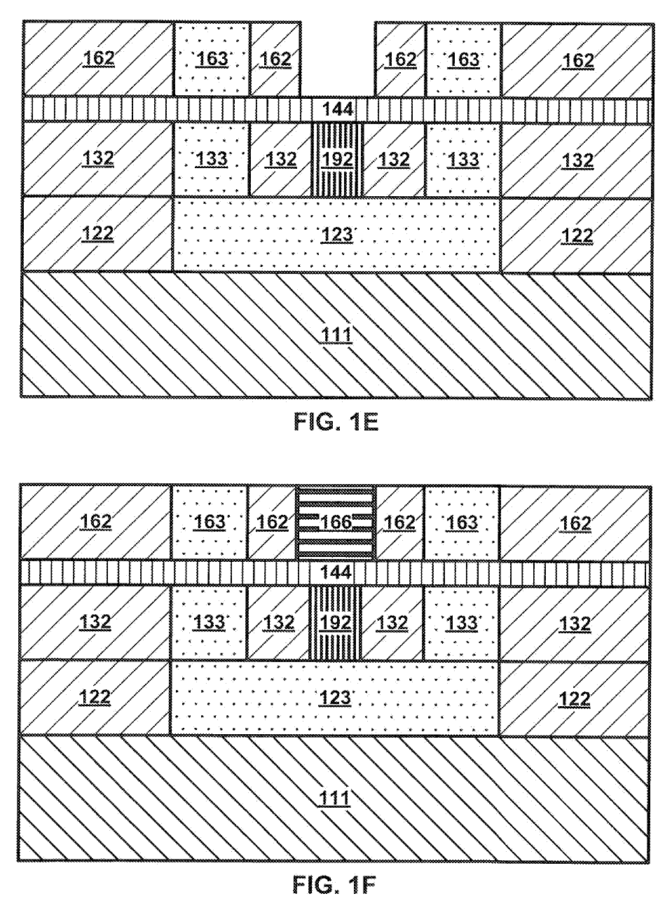

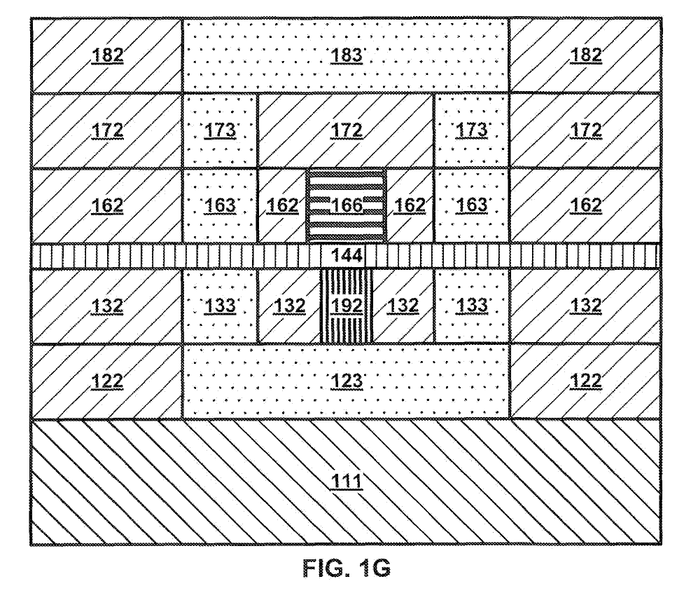

Example FIG. 1A to FIG. 1H illustrates a multi-layer build processes in accordance with one aspect of embodiments.

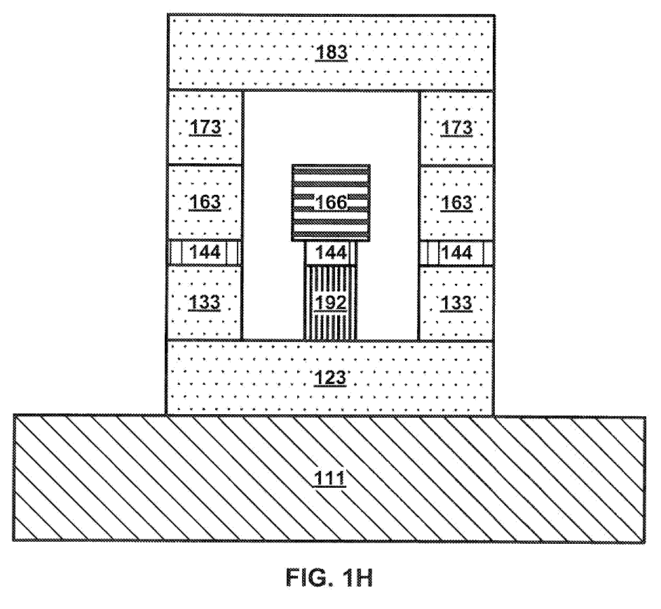

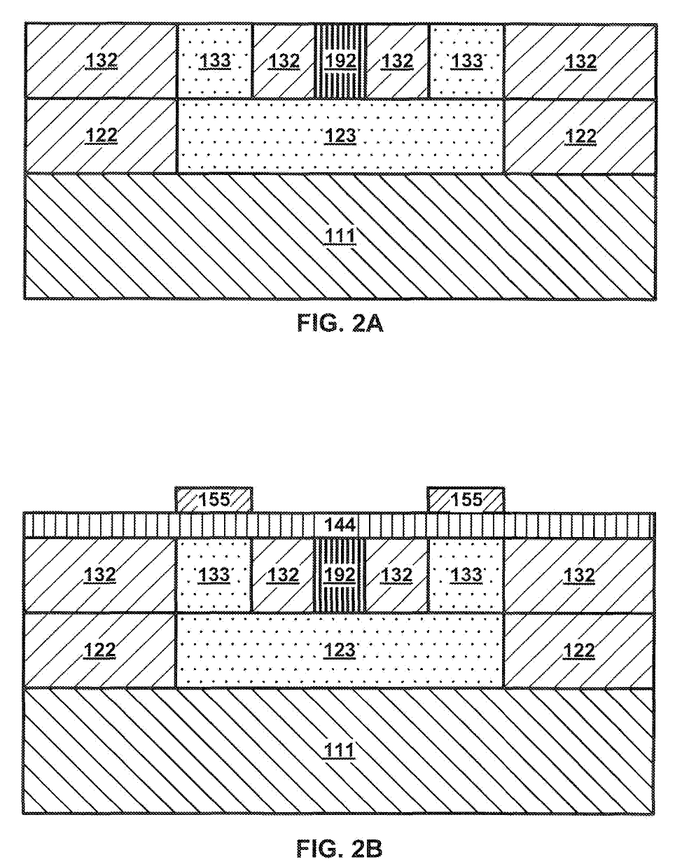

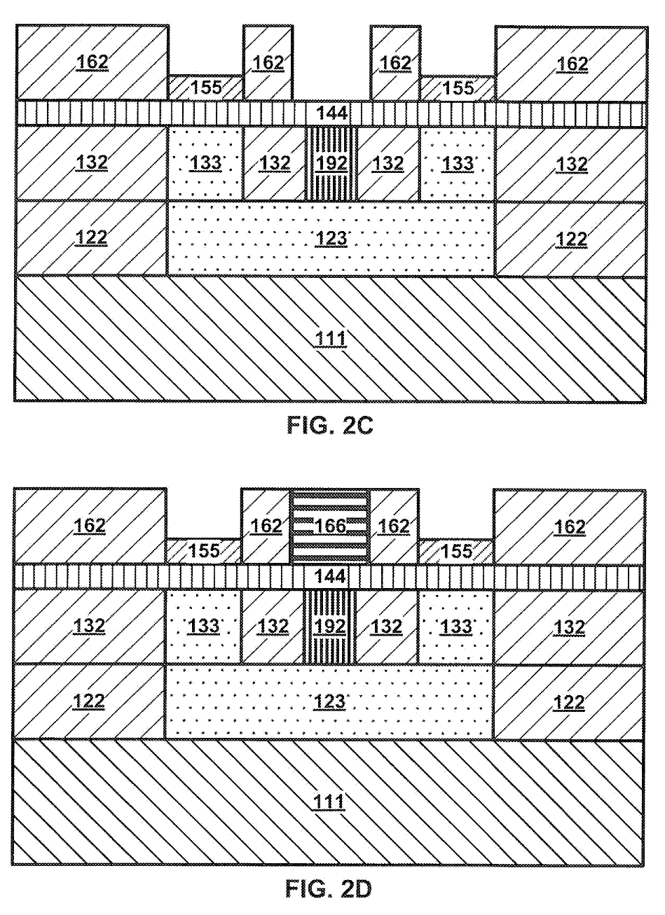

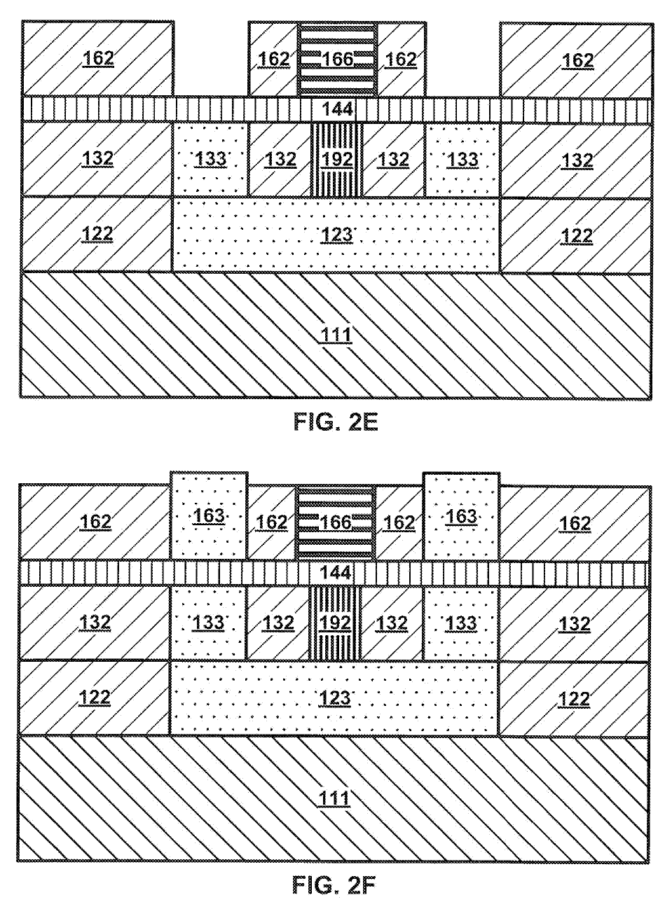

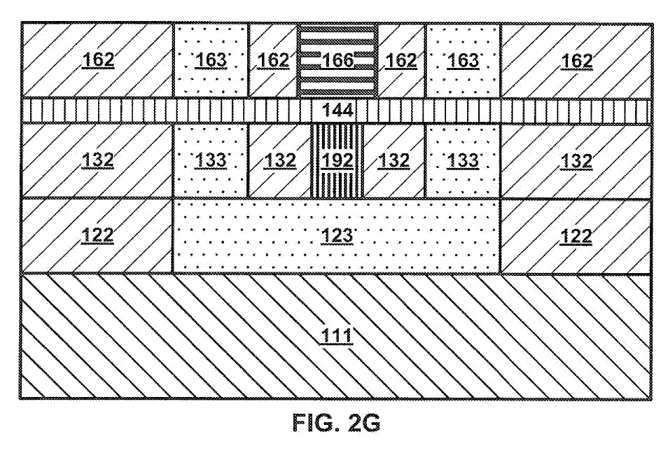

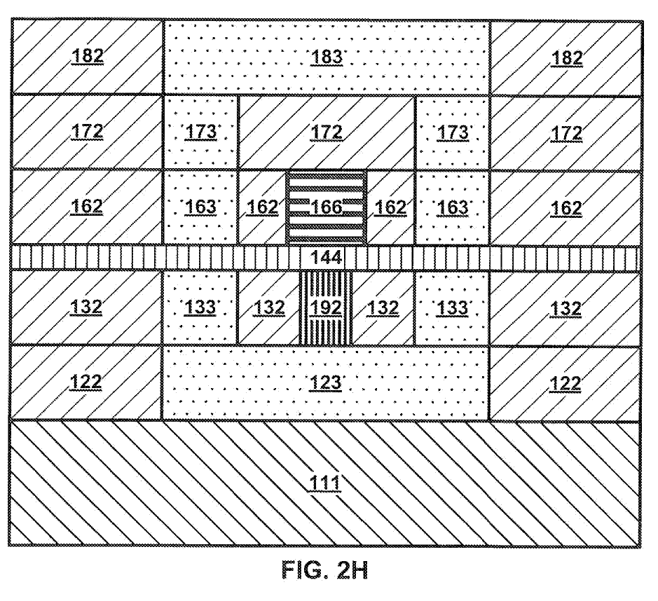

Example FIG. 2A to FIG. 2H illustrates a multi-layer build processes in accordance with one aspect of embodiments.

Example FIG. 3A to FIG. 3C illustrates a multi-layer build processes in accordance with one aspect of embodiments.

Example FIG. 4 illustrates a multi-layer build processes in accordance with one aspect of embodiments.

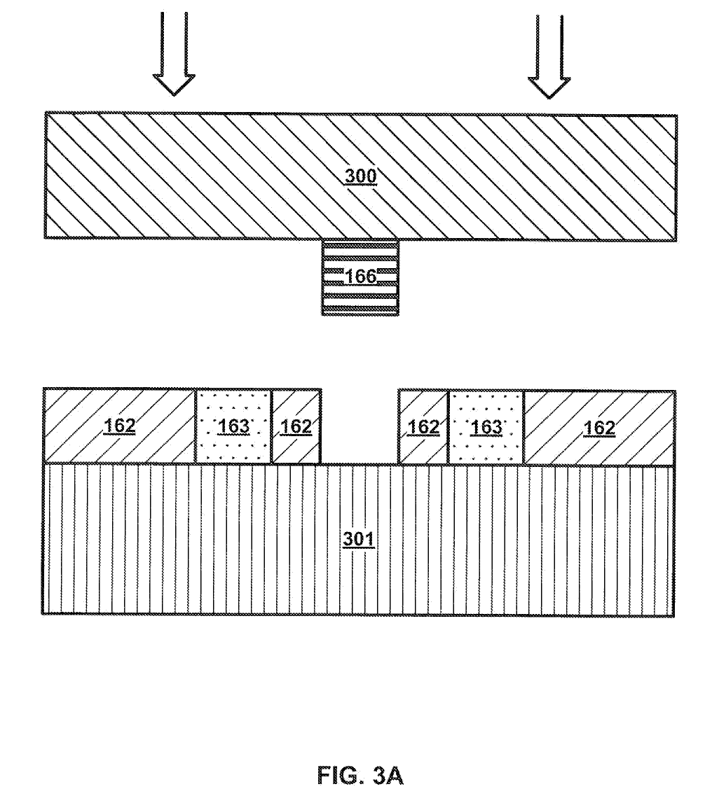

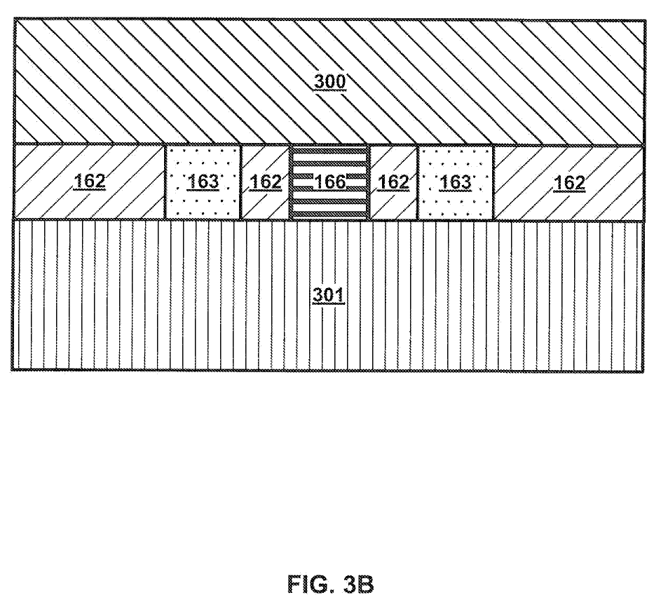

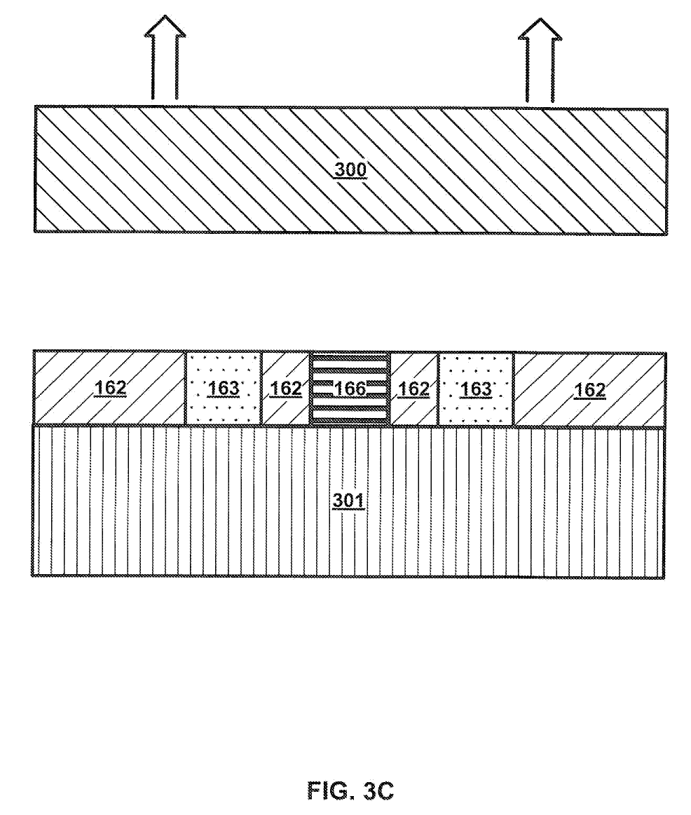

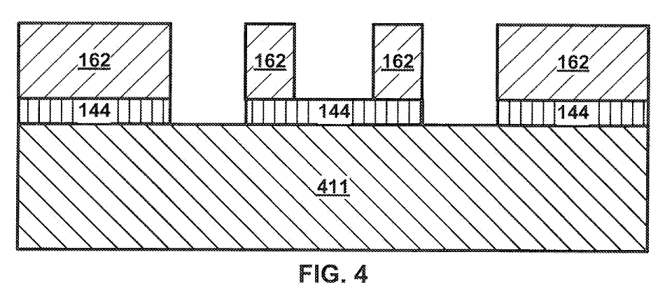

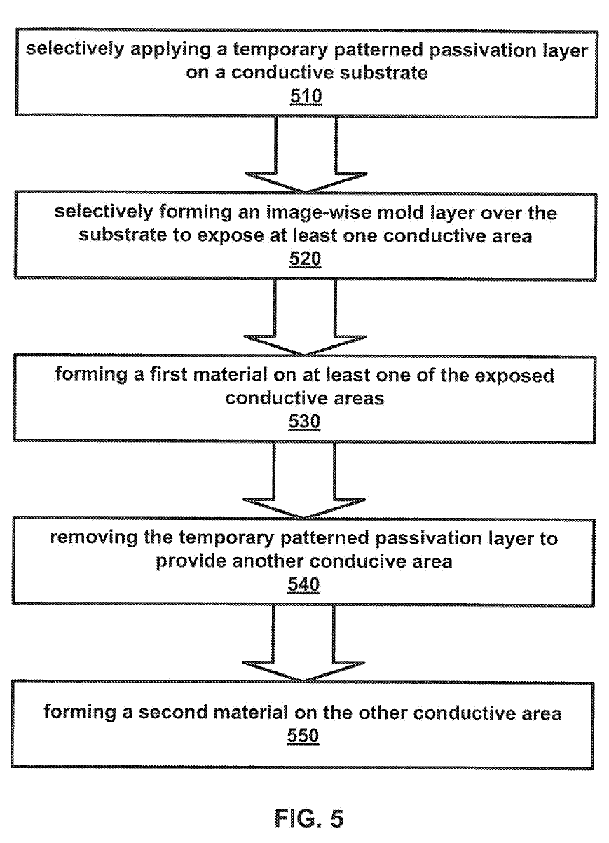

Example FIG. 5 illustrates a multi-layer build processes in accordance with one aspect of embodiments.

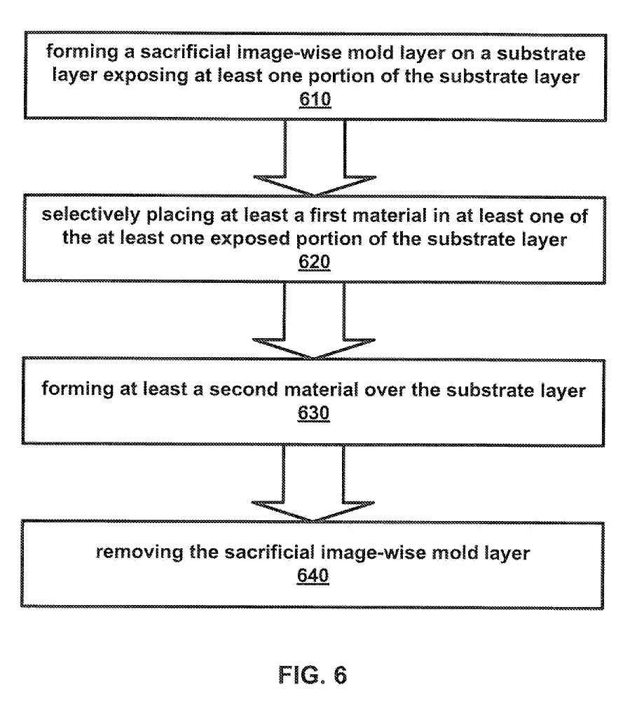

Example FIG. 6 illustrates a multi-layer build processes in accordance with one aspect of embodiments.

Example FIG. 7 illustrates a multi-layer structure in accordance with one aspect of embodiments.

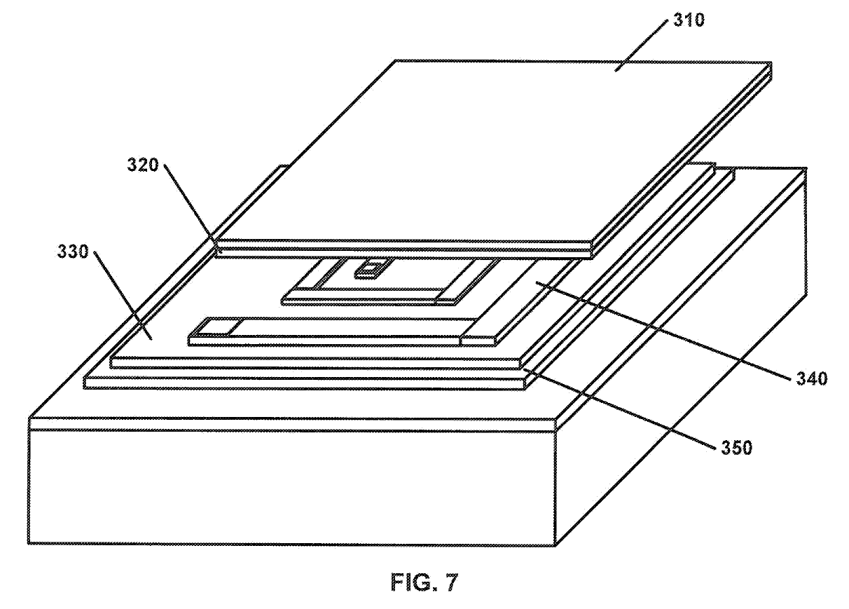

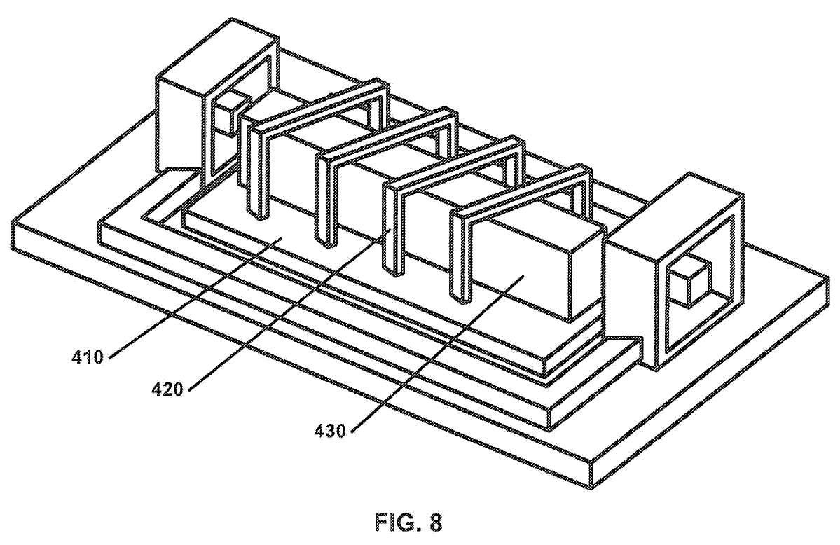

Example FIG. 8 illustrates a multi-layer structure in accordance with one aspect of embodiments.

### DESCRIPTION

Embodiments relate to electric, electronic and/or electromagnetic devices, and process thereof. Some embodiments relate to multi-layer build processes including one or more material integration processes, for example including transfer bonding, lamination, pick-and-place, deposition transfer (e.g., slurry transfer), and/or electroplating on and/or over a substrate layer, which may be mid build of a process flow to create an end device.

Embodiments relate to multilayer structures where the in-plane location of two or more materials, which may be non-insulative, may be defined in the same layer of a multi-layer structure. Embodiments relate to integration of magnetic materials into a multi-layer build process, for example to fabricate an electromagnetic structure. In embodiments, multi-layer build processes may be sufficiently general to be leveraged in various approaches and/or applications where multiple materials may be integrated hybridly and/or monolithically into a mixed material structure.

According to embodiments, the in-plane location of two or more materials which share a layer of a multi-layer structure may be defined. In embodiments, a first non-insulative material and a second non-insulative material may be formed and/or processed in the same layer of a multi-layer structure. In embodiments, the in-plane location on two or more non-insulative materials may be defined to be adjacent each other in the same layer of a multi-layer structure and/or spaced apart from each other. In embodiments, a non-insulative material may include a conductive material, for example Cu, and/or magnetic material, for example NiFe, NiCo and/or other magnetic alloys, which may be also be conductive. In embodiments, a non-conductive ceramic may be incorporated.

According to embodiments, a multi-layer build process may include providing a substrate. In embodiments, a substrate may be conductive, insulative, magnetic and/or non-conductive. In embodiments, a substrate may include one or more substrate layers. In embodiments, a substrate layer may include conductive, insulative, magnetic and/or non-conductive material. In embodiments, for example, a substrate layer may include one or more support structures, illustrated for example in U.S. Pat. Nos. 7,012,489, 7,649,432 and/or 7,656,256, each of which are incorporated by reference herein in their entireties. In embodiments, a conductive substrate layer may include one portion having a conductive material and a second portion having a different conductive material. In embodiments, a substrate layer may be and/or include a permanent dielectric layer including material such as SU-8, BCB, and/or polyamide.

According to embodiments, a multi-layer build process may include providing one or more image-wise mold layers. In embodiments, the term “image-wise” may reference a deliberate pattern and/or art-work, which may define a layer, and the term “mold” may reference a patterned layer which may define the space for incorporation of one or more materials. In embodiments, an image-wise mold layer may be a photoresist. In embodiments, an image-wise mold layer may be a relatively thick photoresist, for example approximately 10 to over 1000 microns in thickness. In embodiments, an image-wise mold layer may be a sacrificial material, which may be removed during and/or at the end of a multi-layer build process. In embodiments, an image-wise mold layer may be a patterned metal layer electroplated through a mask also used to define one or more materials. In embodiments, a patterned metal layer may be a sacrificial material. In embodiments, an image-wise mold layer may be a stamped, cut, photopatterned and/or otherwise formed layer, which may be laminated and/or adhered to a substrate in a multi-layer build process.

According to embodiments, an image-wise mold layer may define, within its patterned bounds, the location of two or more materials, for example adjacent and/or apart from one another. In embodiments, an image-wise mold layer may minimize and/or eliminate separate alignment steps for two or more layers, allowing a single pattern applied at one time to define the location of two or more materials. In embodiments, an image-wise mold layer may minimize and/or prevent the need to apply a mold layer a second time to define a second material. In embodiments, an image-wise mold layer may minimize and/or prevent complications associated with applying a mold layer a second time, for example by minimizing and/or eliminating the challenges of applying a mold layer over a patterned material. Such challenges may include voids, bubbles, striations, and/or other defects associated with applying a mold a second time to a resulting topography of the surface.

Referring to example FIG. 1A to FIG. 1H, a multi-layer build processes is illustrated in accordance with one aspect of embodiments. According to embodiments, a multi-layer additive build process may include forming one or more image-wise mold layers, which may form part of a substrate. As illustrated in one aspect of embodiments in FIG. 1A, two image-wise mold layers having image-wise mold material 122 and/or 132 may be formed on and/or over substrate layer 111. In embodiments, an image-wise mold material may be a relatively thick non-conductive material, for example a photoresist. In embodiments, the thickness of an image-wise mold material may be referenced against the thickness of a passivating layer and/or a seed layer. In embodiments, the thickness of an image-wise mold layer the may be approximately several microns to 1000 or more microns. In embodiments, the thickness of an image-wise mold layer the may be between approximately 10 and 100's of microns.

According to embodiments, one or more processes may be employed to form an image-wise mold layer. In embodiments, processes used to form an image-wise mold layer may include forming a patterned photoresist and/or patterned plastic, forming a patterned metal that may be a sacrificial metal, ink-jet and/or rapid prototyping processes, for example where material is applied from a reservoir through an automated mechanical process. Material may be also applied by extrusion coatings. In embodiments, patterning an image-wise mold layer may be accomplished by any suitable process, for example cutting and/or milling by laser and/or mechanical processes. In embodiments, an image-wise mold layer may be a sacrificial material that is removed at the end of the processing leaving behind the materials it defines.

As illustrated in one aspect of embodiments in FIG. 1A, two image-wise mold layers may be formed over substrate layer 111, and/or may have image-wise mold material 122 and/or 132 together with any other suitable material. In embodiments, any material may fill an image-wise mold layer, for example conductive material and/or insulative material. In embodiments, an image wise mold may be filled by metal material 123 and/or 133, and/or by dielectric material 192. In embodiments, a material may fill a mold by any suitable process, for example including an electroplating and/or squeegee process. In embodiments, for example where dielectric material 192 may be formed in a squeegee process or doctor blade process, a layer of permanent passivation material may be formed such that dielectric material 192 is formed on the permanent passivaiton material, for example after metal material 133 has been electrodeposited. In embodiments, a pick-and-place process, transfer-bonding process and or lamination process may be employed to insert material 192 between image-wise mold material 132.

According to embodiments, a multi-layer build process may include forming one or more seed layers on a substrate. In embodiments, a seed layer may be disposed between two layers in a multi-layer build process, for example between two image-wise mold layers. In embodiments, a seed layer may be a conductive layer used to facilitate growth, for example in electroplating at least a portion of a next layer. In embodiments, a first non-insulative material and/or a second non-insulative material may be formed by any suitable process, for example wafer bonding, lead-frame bonding, pick-and-place, dispensing, lamination vapor deposition and/or by electrodeposition. In embodiments, a seed layer may be used to facilitate formation of any material, for example semiconductive and/or insulative material. For example, deposition of non-conductors (e.g. semiconductors and insulators) has be presented in related art.

According to embodiments, a seed layer may be formed, for example on and/or under an image-wise mold layer as illustrated in one aspect of embodiments in FIG. 1B. In embodiments, a seed layer may be modified, for example by selectively applying a patterned passivation layer on and/or over the seed layer. In embodiments, a patterned passivation layer may be temporary, such that it may be removed to expose a portion of an underlying seed layer. In embodiments, selectively applying a temporary patterned passivation layer may include depositing a layer of passivation material on a seed layer and patterning the passivation material to expose a portion of the seed layer. In embodiments, selectively applying a temporary patterned passivation layer may include selectively placing passivation material on a seed layer to block a portion of the seed layer. In embodiments, a passivation layer may be thin, for example substantially thinner relative to the thickness of an image-wise mold layer. In embodiments, a passivation layer may be a relatively thin non-conductive film, for example a relatively thin photoresist. Referring to FIG. 1B, seed layer 144 may be modified by temporary patterned passivation layer 155.

According to embodiments, a seed layer may be modified by any suitable process. In embodiments, for example, a seed layer may be modified by selectively removing a portion of the seed layer. In embodiments, selectively removing a portion of the seed layer may expose a non-conductive portion of a layer underlying the seed layer. Referring to FIG. 1B, for example, selectively removing seed layer 144 in the area above image-wise mold material 132 may expose non-conductive material 132. In embodiments, for example where a material is desired to be formed over dielectric material 192, passivation layer 155 may not be formed over insulation material 192 where seed layer 144 is present, and/or may be formed on and/or over metal material 133, such that a first material may be formed on the remaining exposed portion of seed layer 144 located on insulation material 144.

Referring to example FIG. 4, for example, seed layer 144 may formed on non-conductive substrate 411, by selectively depositing and/or selective removal, to define one or more areas in which a first material may be formed. In embodiments, a seed layer may nucleate selective growth of materials through any suitable process, for example including CVD, PVD, and/or electroless deposition of materials. In embodiments, employing a passivated and/or patterned seed layer may enable material to be formed in an image-wise mold where the seed layer is exposed in the pattern. Such methods producing selective deposition based on the exposed surface chemistry are available in related art.

Referring back to FIG. 1C, an image-wise mold layer may be formed over a substrate, a seed layer and/or a passivation layer. In embodiments, an image-wise mold layer may be applied and/or patterned to cooperate with a substrate, seed layer and/or passivation layer, and/or define the in-plane location of two materials sharing the same layer of a multi-layer structure. In embodiments, an image-wise mold may expose one or more conductive areas. As illustrated in one aspect of embodiments in FIG. 1C, an image-wise mold layer may be selectively formed over passivation layer 155, seed layer 144 and substrate 111, and expose two conductive areas. In embodiments, the two conductive areas may include the exposed areas of seed layer 144. Referring to FIG. 1D, first material 163 may be formed on the exposed portion of seed layer 144. In embodiments, first material 163 may be formed by any suitable process, for example the electrodepositing process. Referring to FIG. 1E, layer 155 may be removed. In embodiments, a passivation layer may be removed by any suitable process, for example by an etching process. In embodiments, removing layer 155 may expose a seed layer, as illustrated in one aspect of embodiments in FIG. 1E, and/or may expose a conductive and/or non-conductive portion of a layer underlying the passivation layer.

Referring to FIG. 1F, second material 166 may be formed on and/or over an exposed portion of seed layer 144. In embodiments, a second material may be formed by any suitable process, for example electrodeposition. In embodiments, electrodeposition may include electroplating insulative, conductive, and/or semiconducting materials. As illustrated in one aspect of embodiments in FIG. 1F, the in-plane location of first material 133 and second material 166, which share the same layer of the multi-layer structure, may be defined to be spaced apart from each other. Referring to FIG. 1G, image-wise mold material 162 and 182 form two image-wise mold layers over substrate 111. In embodiments, the two formed image-wise mold layers may be filled with any suitable material, for example metal material 173 and/or 183. Referring to FIG. 1H, one or more materials of a multi-layer structure may be removed, for example mold material 122, 132, 162, 172 and/or 182. In embodiments, end structures formed may be left on and/or over a substrate, for example a wafer, and/or detached from a substrate to mount into other systems. Referring to example FIG. 1H, a multi-layer structure is illustrated in accordance with one aspect of embodiments, which may or may not be removed from substrate layer 111.

In embodiments, one or more of layers of a multilayer structure may be made approximately planar to facilitate the application of a new mold material and/or subsequent layer. In embodiments, planarization may be accomplished by any suitable process, for example including chemical-mechanical polishing (CMP), lapping, polishing, mechanical cutting such a fly-cutting and/or diamond turning, etching, and/or mechanical scraping such as a though a doctor blade or squeegee. In embodiments, application of a mold material, formation of a first and/or second material, and/or planarization methods may be selected based on various factors, for example including mechanical scale (e.g., dimensions), materials required in a final construction, chemical compatibility of the process and/or precision.

Referring to example FIG. 2A to FIG. 2H, a multi-layer build processes is illustrated in accordance with one aspect of embodiments. In embodiments, the order of formation of a first material and a second material may be determined, in part, by the configuration of the image-wise masking material. In embodiments, for example in the process illustrated in FIG. 2A to FIG. 2H, the first material formed may be material 166, as illustrated in FIG. 2D, and the second material formed may be material 163, as illustrated in FIG. 2F. In embodiments, the order of formation of first material 163 and second material may be determined, in part, by the configuration of the seed layer, the passivation layer and/or the image-wise masking layer. In embodiments, one or more layers of the multi-layer structure may be planarized as illustrated in FIG. 2G. In embodiments, the first and the second material may be different from each other.

Referring to FIG. 3A to FIG. 3C, a multi-layer build processes is illustrated in accordance with one aspect of embodiments. In embodiments, the order of formation of a first material and a second material may be determined, in part, by the process employed. In embodiments, a placing process may be employed to form a material in a multi-layer structure. As illustrated in one aspect of embodiments in FIG. 3A, an image-wise mold layer including mold material 162 and/or metal material 163 may be formed on substrate 311. In embodiments, second material 166 may be selectively placed in the area exposed by the image-wise masking mold layer. In embodiments, material 166 may be affixed to carrier substrate 300 and then affixed to the substrate layer 301, as illustrated in one aspect of embodiments in FIG. 3B. Referring to FIG. 3C, carrier substrate material 300 may be released. In embodiments, affixing the material may be accomplished by any suitable process, for example employing adhesive, heat and/or pressure. In embodiments, material 166 may be patterned before being transferred, and/or may be first transferred and then patterned. In embodiments, mold material 162 may be sacrificial material, such that it may be removed.

According to embodiments, any suitable process may be employed to place a material on and/or over a substrate. In embodiments, a lamination process may be employed. In embodiments, a material may be patterned before and/or after it is laminated to a substrate layer. In embodiments, a material may be supported by a support lattice, for example to suspend the first material before it is laminated, and then the first material that is laminated to the substrate layer. In embodiments, a material may be dispensed, for example in an area exposed by a image-wise mold layer. Therefore, processes which may be employed to form a material may include one or more of, for example, an electrodeposition process, a transfer bonding process, a dispensing process, a lamination process, a vapor deposition process, a screen printing process and/or a squeegee process.

Referring to example FIG. 5, a multi-layer build processes is illustrated in accordance with one aspect of embodiments. According to embodiments, a temporary patterned passivation layer may be selectively applied on and/or over a conductive substrate, 510. In embodiments, an image-wise mold layer may be selectively formed on/and or over the substrate to expose at least one conductive area, 520. In embodiments, a first material may be formed on and/or over one or more of the exposed areas, 530. In embodiments, the temporary patterned passivation layer may be removed, which may provide another conducive area, 540. In embodiments, a second material may be formed on/and or over the other conductive area, 550.

According to embodiments, a blocking material may be formed, for example on and/or over a conductive portion of a substrate layer to block formation of a material in a layer of a multi-layer structure. In embodiments, a blocking material may include ceramic material. In embodiments, a ceramic material may be preformed and inserted into one or more portions of an image-wise mold layer, for example prior to forming a first and/or a second material of the multi-layer structure.

Referring to example FIG. 6, a multi-layer build processes is illustrated in accordance with one aspect of embodiments. According to embodiments, an image-wise mold layer may be formed on a substrate layer exposing at least one portion of the substrate layer, 610. In embodiments, a first material may be selectively placed in one or more exposed portion of the substrate layer, 620. In embodiments, a second material over the substrate layer, 630. In embodiments, an image wise-mold layer may include sacrificial material, which may be removed, 640.

According to embodiments, selectively placing a material may include a lamination process. In embodiments, a material may be patterned before and/or after the material is laminated. In embodiments, placing may include a transfer bonding process, for example where a first material is supported by a support lattice to suspend the first material before it is laminated, and then the first material is laminated to the substrate layer. In embodiments, placing may include a dispensing process, wherein the first material is selectively dispensed. In embodiments, placing may include a pick-and-place process, and/or any other suitable process.

Embodiments relate to devices, for example formed by multi-layer build process in accordance with aspects of embodiments. As illustrated in example FIG. 7, a device formed may include first non-conductive material 320, for example insulative material, formed on first non-insulative material 310, for example magnetic material. In embodiments, conductive material 340 exhibiting a pattern, for example a copper coil, may be placed and/or formed on second non-conductive material 330 by any suitable process, for example electrodeposition, transfer bonding, pick-and-place, which may employ an image-wise masking layer, a seed layer and/or a passivation layer in accordance with embodiments. In embodiments, an image-wise masking layer may include sacrificial material, which may be removed at the end the multi-layer build process. In embodiments, second non-conductive material 320 may be formed between conductive material 340 and second magnetic material 310.

Embodiments relate to devices, for example formed by multi-layer build process in accordance with aspects of embodiments. As illustrated in example FIG. 8, a device formed may include non-conductive material 410, for example insulative material. In embodiments, first non-insulative material 420 and/or second non-insulative material 430 may be formed on non-conductive material 410 by any suitable process, for example electrodeposition, transfer bonding, pick-and-place, which may employ an image-wise masking layer, a seed layer and/or a passivation layer in accordance with embodiments. In embodiments, an image-wise masking layer may include sacrificial material, which may be removed at the end the multi-layer build process. In embodiments, for example, first non-insulative material 410 may include magnetic material, for example NiFe, and/or second non-insulative material 420 may include conductive material, for example copper.

Example Electrodeposition and Hybrid Embodiments

According to embodiments, a first material and/or a second material which form a portion of a multilayer structure may be electrodeposited in at least a part of the same layer of the structure. In embodiments, a first material, for example copper, may be electrodeposited in a layer of a multi-layered structure and a second material, for example NiFe, may be electrodeposited in the same layer as the copper. The first material and the second material may be adjacent and/or spaced apart from the second material in the same layer. In embodiments, pulse and/or reverse pulse plating techniques may be employed. In embodiments, a first material may be formed by an electrodeposition process and a second material be formed by a an electrodeposition process together with any other suitable process, for example a transfer bonding process, a pick-and-place process, a dispensing process and/or a lamination process in the same layer and/or a different layer of a multilayer structure.

According to embodiments, the first material and the second material may be processed, for example planizied, after electrodeposition. Planrization may be accomplished by a chemical-mechanical planarization (CMP) process after the conductive material and/or the magnetic material has been electrodeposited in accordance with one aspect of embodiments. Planarizing a magnetic material may substantially minimize problems associated with across-wafer thickness uniformity in accordance with one aspect of embodiments. In embodiments, a useful yield of relatively thick cores for magnetic microelectricalmechanical (MEMS) systems may be maximized. In embodiments, for example, CMP processes may works relatively well on copper, while CMP processes for NiFe and/or Ni may be relatively slow. In embodiments, CMP rates between approximately 0.5 micron per min and 5 micron per min may minimize uniformity issues associated with high speed plating. CMP may be employed to selectively stop at a layer that is not substantially polished in a chosen chemistry, for example to stop on a mold layer such as a photoresist. In embodiments, some or all materials in a layer may be planrized simultaneously through mechanical means such as lapping and/or polishing, flycutting, surface grinding or diamond turning. In embodiments, such mechanical methods may maximize speed, depending on the materials, provide an ability to planarize materials that do not have CMP methods, and/or the ability to adjust multiple materials to a chosen thickness.

According to embodiments, one or more molds may be used to electrodeposit a first material and second material over selected portions of a substrate and/or an underlying layer of a multi-layer structure. In embodiments, a mold may include resist material. In embodiments, a relatively thin passivation layer may be formed on and/or over a substrate and/or a seed layer. In embodiments, a passivation layer may be selectively deposited and/or may be etched, such that an underlying layer may be exposed. In embodiments, the relatively thin passivation layer may be a patterned resist layer and/or a patterned dielectric layer, for example inorganic dielectric material.

According to embodiments, one or more molds may be formed over the substrate such that regions of a seed layer, passivation layer and/or conductive substrate layer may be exposed. In embodiments, portions of a seed layer and/or a conductive portion of a conductive substrate layer where the passivation layer exists will not be modified when a first material is electrodeposited, leaving one or more unfilled regions of the mold. A passivation layer may be removed, for example by plasma and/or chemical etching, and/or by selective stripping, after and/or before electrodepositing a first material in one aspect of embodiments. In embodiments, a second material may then be electordeposited in the mold, providing two relatively thick electrodeposited layers of different materials located in at least a part of the same layer of the multilayer structure. In embodiments, planarization can then occur and to form two different materials in the same layer of the structure.

According to embodiments, a seed layer may be selectively deposited and/or etched to define where a first and/or second material is formed. In embodiments, a conductive substrate layer may include non-conductive material, such that a seed layer may be formed on and/or over one or more non-conductive portions. In embodiments, non-conductive portions of the conductive substrate layer may not be modified, leaving one or more unfilled regions of the mold. A first material may be electrodeposited over the exposed portions of the seed layer in accordance with one aspect of embodiments. In embodiments, a second material may be formed in the unfilled regions by any suitable process. In embodiments, where a second material is electrodeposited in one or more unfilled regions of a mold, a seed layer may be formed in the unfilled regions and then the second material may be electrodeposited in one or more portions of the mold. The first electrodeposited material may be passivated before the second electrodeposited material is formed, for example, to prevent deposition on the first material.

According to embodiments, a capping process may finish an electrodeposition step of a relatively high permeability material with copper to overfill a mold for CMP. In embodiments, a relatively high permeability material electrodeposition step may stop at between approximately 70% and 90% fill of a trench of a mold. In embodiments, copper may complete and/or overfill a resist mold for a layer. In embodiments, a CMP process may planarize each layer while allowing substantially all of the layers to be made of materials that may not be typically CMP processed with copper.

According to embodiments, in-plane and/or out of plane dimensional control across a wafer for films may be provided, where for example thickness uniformity would typically be problematic. In embodiments, relatively high force, high throw capability of micromagnetic elements with an array of multi-layer flexures and/or mechanisms may be provided. In embodiments, a permanent dielectric may allow membranes, electrical isolation and/or floating elements within a build. In embodiments, a magnetic material may be used to create a second mechanical material. Copper may include desirable properties as a micro-mechanical material, including the ability to self-anneal at room temperature, between approximate 50 MPa and 70 MPa yield strength, approximately 117 MPa fatigue strength at approximately 10̂1 cycles, a young's modulus of approximately 115 GPa, and/or residual stress of between approximately 10 MPa and 20 MPa. In embodiments, any non-insulative material may be employed, for example Aluminum, Iron, Gold, Lead, Nickel, Silicon, Silver, Tantalum, Silver, Tin, Titanium, Tungston and/or Zinc.

Example Transfer Bonding and Hybrid Embodiments

According to embodiments, a first material and/or a second material which may form a portion of a multilayer structure may be formed in at least a part of the same layer of the structure. In embodiments, a first material, for example magnetic material, may be transfer bonded in a layer of a multi-layered structure and a second material, for example Cu, may be formed in the same layer of the multi-layer structure as the copper material. In embodiments, the same material may be formed in the lame layer. The first material and the second material may be adjacent and/or spaced apart from the second material in the same layer. In embodiments, a first material may be formed by a transfer bonding process and a second material be formed by any suitable process, including an electrodeposition process, a transfer bonding process, a pick-and-place process, a dispensing process and/or a lamination process in the same layer and/or a different layer of a multilayer structure.

In embodiments, transfer bonding may involve providing a material, for example magnetic material, attached to a first carrier substrate to process, align and/or attaching it to a device, for example a multil-layer structure. In embodiments, the material may be released from a carrier substrate, for example a handle wafer. In embodiments, the material may successfully bind to a device and/or substrate layer, for example a wafer. In embodiments, contamination may be minimized, for example from a handle adhesive. In embodiments, a material may be processed before and/or after it is transferred.

According to embodiments, bonding material may be provided for a carrier substrate that may withstand a patterning processes, including materials that may endure etching chemicals, laser processing, and/or photopatterning materials. In embodiments, such material may readily release parts it holds. In embodiments, bonding materials may not transfer and/or may have to be removed from transferred materials, for example magnetic materials. In embodiments, bonding material may include 3M WSS and/or dry-film adhesive tapes such as Sekisui, Revalpha and/or Rexpan. In embodiments, a variety of adhering and/or release mechanisms may be provided, for example maintaining relatively mild attack (WSS) in a film that relatively cleanly releases when a device is relatively more adhesively held, UV release adhesive, and/or thermal release adhesive. Bonding material may account for chemical compatibility of such materials with etchants for desired alloys. In embodiments, various approaches to bonding for wafer thinning applications, such as wafer bond HT by MicroChem, may be applicable. In embodiments, solvent release resins may be employed with bonding to a wafer that may be coated in resist in accordance with one aspect of embodiments. In embodiments, UV and/or thermal release may be employed.

According to embodiments, an adhesion material may be provided. In embodiments, a layer may include a temporary layer, such as a relatively thin layer of positive resist (e.g.: Shipley 1813), and/or thermally curable adhesive. In embodiments, such a layer may be spin-coated on and/or over a substrate (e.g., a substrate layer) between approximately 0.5 and 3 micron, and/or may be partially cured. In embodiments, components may be aligned, tacked, and/or compression bonded allowing a transfer adhesive to cure. In embodiments, for example after release of a substrate handle, material may be removed between gaps of transferred material to allow metal, for example copper, to be re-exposed, for example to complete a coil construction. In embodiments, dry etching may be employed. In embodiments, negative resists such as SU-8 may be employed since they may not be substantially cross-linked by UV through materials, for example opaque magnetic materials. In embodiments, other processes which may be employed may include coating a material to be transferred with an adhesive material through spray coating. In embodiments, enabling alignment and/or minimizing substantial “squeeze-out” during a compression thermal bonding process may be provided.

In embodiments, a transferred material may be etched. In embodiments, laser cutting and/or powder blasting may be employed. In embodiments, for example when bulk material is removed, wet etching may be employed. In embodiments, rolls of material may be processed by wet etching techniques. In embodiments, Ni and/or Fe alloys may be etched in concentrated nitric and/or HCl, considering bonding material attack may be considered. In embodiments, Ferric chloride including a relative small quantity of HF may be employed, and/or may have a relatively mild effect on adhesives.

According to embodiments, processes may account for the fact that etching methods may be isotropic in nature, which may make aspect ratio, minimum hole size, and/or sidewall profile further considerations. In embodiments, chemical etching may involve an isotropic undercut. In embodiments, double sided etching may be employed, and/or in a transfer bonding approach, both sides may need to be aligned in a double sided aligner and/or exposed to minimize back side alignment problems in metal. In embodiments, an etching process may be enhanced by employing electro-chemical etching. In embodiments, a work piece may be made anodic in an etching bath. In embodiments, electrochemical machining (ECM) may enable greater than approximately 2:1 aspect ratios. In embodiments, leveraging ECM may include employing relatively milder etchants (including salts), which may provide greater compatibility with temporary bonding agents. In embodiments, ion milling and/or dry etching may be possible for relatively thin layers.

According to embodiments, a material may be aligned in a transfer bonding process. In embodiments, for example if a material is wafer-scale hybridly integrated, a material may be aligned and/or bonded to wafers considering run-out, planarity, CTE, dimensional accuracy and/or planarization. Each layer in a processed device wafer may produce variations in planarity due to film thickness variations across a wafer and/or bow/warp phenomena. Such variations may be introduced in a multi-layer thick resist process, for example as a result of accumulation of relatively small variations across the surface. In embodiments, such variations may be minimized such that components may be brought into intimate contact during a bonding process without substantially changing alignment and/or preventing intimate contact for bonding.

According to embodiments, minimizing bubbles from relatively thick resist processing, for example to build coils, may be provided. Transfer bonding of bulk parts may create voids with small pockets in, around and/or under elements. This may result from material finish, local height variation on a wafer and/or imperfect adhesion. Baking a resist may cause gas expansion that forces air into materials during cure. In one example, due to a viscosity of materials, bubbles may become trapped and/or produce local thickness variations that may impact yield. In embodiments, precision transfer, proper tolerancing, and/or vacuum outgassing processes may be employed to minimize bubbles.

According to embodiments, planarization processes may be employed to planarize one or more layers in a transfer bonding process. In embodiments, for example, resist may be planarization over magnetic material. In embodiments, a magnetic material be bonded to a wafer and a build process may continue. In embodiments, for example, 25 microns of strap material may be overcoated by 100 micron resist without substantial difficulty. Dielectric strap materials may be formed from photopatternable dielectrics. Such straps may be used to suspend or separate one or more materials in a build electrically and/or mechanically. Such approaches to suspend elements such as center conductors are illustrated in U.S. Pat. Nos. 7,012,489, 7,649,432 and/or 7,656,256.

According to embodiments, increasing thickness of a magnetic material over an approximate 1:4 ratio may have impacts on resist coating and/or an ability to self-level. In embodiments, for example if spin-coating becomes problematic as a material thickness becomes an increasing fraction of a resist thickness (approximately 1:1), squeegee or doctor blade coating techniques may be used to apply mold or other materials to the build. Squeegee coating may minimize trapped air and maximize top surface clean-up, edge uniformity, and/or general process control. In embodiments, squeegee coating or doctor blade approach may enable forming resist thicknesses that are substantially level with magnetic material, and/or using magnetic material as a hard stop for a squeegee. In embodiments, clean-up of residual resist may be accomplished employing CMP and/or lapping, and/or dry etching, for example where residual thickness of resist for clean-up is relatively small. In embodiments, transfer bonding elements may be provided into recesses left in a resist layer either before and/or after plating and/or planarization, for example in hybrid plating.

According to embodiments, electrical shorting may be minimized. In embodiments, some ferromagnetic materials may be electrically conductive. In embodiments, passivation and/or electrical isolation processes may be deployed to ensure structures, such as coils coils may not be shorted. In embodiments, for example where conductive magnetic materials may be in contact with a coil, passivation materials such as spray coated, CVD, thermally deposited, sputtered and/or PECVD deposited dielectrics may be used. For example, paralene coatings and/or ALD coatings may be used. In embodiments, coatings may be chosen on their ability to minimize the magnetostrictive and/or other mechanical forces on the magnetic materials, and/or to prevent corrosion of the magnetic materials. Also, for example, forces from CTE mismatch between materials.

According to embodiments, stray Eddy Currents may be minimized. In embodiments, employing bulk foil ferromagnetic materials may allow maximized magnetic properties. This may be due to the inability for a multi-layer build to process bulk magnetic materials using the thermal and mechanical operations possible in bulk material processing. For example, in metglass, mu-metals, supermalloy and such materials high temperature processing may be incompatible with most multi-layer build processes and similar properties may be otherwise difficult to produce due to purity, grain size, crystal orientation, amorphous structures, etc. In embodiments, for example in AC applications (e.g., transformers, inductors, etc) many conductive ferromagnetic materials suffer from magnetic loop eddy current along a path of a primary loop flux that may produce a parasitic loss. In embodiments, loss may be minimized by incorporating electrical discontinuities and/or using relatively very thin layers. In embodiments, for example in transformers, magnetic loop losses may be addressed using laminated sheets that may have electrical discontinuities (E/I and/or C-cores). In embodiments, relatively small gaps may remain in place creating saturable cores and/or more than one complimentary layer maybe laminated together, alternating gap locations and/or providing a continuous magnetic path but a discontinuous electrical path.

At relatively higher frequencies, eddy currents may appear within a thickness of a material, which may be addressed in one aspect of embodiments by employing relatively very thin ferromagnetic layers and/or by using ferrites. In embodiments, fabricating micro-laminate cores may be employ a transfer bonding process, repeatedly, to create a micro-magnetic laminate. In embodiments, a relatively easy approach to E/I and/or C core approach may be to use relatively very thin ferromagnetic layers laminated together maximizing main loop electrical resistance while maximizing the frequency of operation for eddie currents within a thickness. In embodiments, foils of permalloy may be employed between approximately 5 micron and 13 micron layers. Using relatively thin layers bonding a laminate may be employed that may operate at MHz frequencies and/or may have minimal conductive losses which may extend a useable range of these materials. In embodiments, electroplating and/or sputtering between approximately 1 micron and 5 micron ferromagnetic layers with intervening dielectrics may be done on and/or over a handle wafer and transfer bonded, and/or performed using monolithic approaches. In some approaches, the effects of a lamination can be approximated by modulating the material properties during a deposition, for example, in reverse pulse plating the phosphorous content in Ni—P or Co—P can be modulated to interrupt the magnetic eddy currents.

Example Lamination and Hybrid Embodiments

According to embodiments, a first material and/or a second material which may form a portion of a multilayer structure may be formed in at least a part of the same layer of the structure. In embodiments, a first material, for example magnetic material, may be laminated to a substrate layer of a multi-layered structure and a second material, for example Cu, may be formed in the same layer of the multi-layer structure as the copper material. The first material and the second material may be adjacent and/or spaced apart from the second material in the same layer. In embodiments, a first material may be formed by a lamination process and a second material be formed by any suitable process, including an electrodeposition process, a transfer bonding process, a pick-and-place process, a dispensing process and/or a lamination process in the same layer and/or a different layer of a multilayer structure.

According to embodiments, a material, for example magnetic material, may be incorporated into a build process. In embodiments, direct lamination may possible for deformable polymer films, and/or Al foils. In embodiments, a lamination process may include forming lead-frame sheets, for example where a substantially all elements are mechanically interconnected through a support lattice. In embodiments, a free-standing sheet of material may be laminated and/or transfer bonded to a wafer. In embodiments, a support lattice may be removed during die separation. In embodiments, as previously discussed, spin-coating, bubble minimizing, dielectric coating, adhesion, and/or planarization processes may be employed in a lamination process. In embodiments, designs that may accommodate residual features of a support network, device packing density from a support lattice, and/or thicknesses that allow physical handling may be considered. Relative simplicity of a lamination process may be relatively high and/or dimensions may be attractive to a device design space.

Example Dispensing and Hybrid Embodiments

According to embodiments, a first material and/or a second material which may form a portion of a multilayer structure may be formed in at least a part of the same layer of the structure. In embodiments, a first material, for example non-conductive material, may be dispensed in a layer of a multi-layered structure and a second material, for example Cu, may be formed in the same layer of the multi-layer structure as the copper material. The first material and the second material may be adjacent and/or spaced apart from the second material in the same layer. In embodiments, a first material may be formed by a transfer bonding process and a second material be formed by any suitable process, including an electrodeposition process, a transfer bonding process, a pick-and-place process, a dispensing process and/or a lamination process in the same layer and/or a different layer of a multilayer structure.

According to embodiments, increasing thickness of a magnetic material over an approximate 1:4 ratio may have impacts on resist coating and/or an ability to self-level. In embodiments, for example if spin-coating becomes problematic as a magnetic material thickness becomes an increasing fraction of a resist thickness (approximately 1:1), squeegee coating may be used. Squeegee coating may minimize trapped air and maximize top surface clean-up, edge uniformity, and/or general process control. In embodiments, squeegee coating may enable forming resist thicknesses that are substantially level with magnetic material, and/or using magnetic material as a hard stop for a squeegee. In embodiments, clean-up of residual resist may be accomplished employing CMP and/or lapping, and/or dry etching, for example where residual thickness of resist for clean-up is relatively small. In embodiments, transfer bonding elements may be provided into recesses left in a resist layer either before and/or after plating and/or planarization, for example in hybrid plating.

Example Pick-and-Place and Hybrid Embodiments

According to embodiments, a first material and/or a second material which may form a portion of a multilayer structure may be formed in at least a part of the same layer of the structure. In embodiments, a first material, for example magnetic material, may be transfer bonded in a layer of a multi-layered structure and a second material, for example Cu, may be formed in the same layer of the multi-layer structure as the copper material. The first material and the second material may be adjacent and/or spaced apart from the second material in the same layer. In embodiments, a first material may be formed by a transfer bonding process and a second material be formed by any suitable process, including an electrodeposition process, a transfer bonding process, a pick-and-place process, a dispensing process and/or a lamination process in the same layer and/or a different layer of a multilayer structure.

According to embodiments, non-conductive materials and/or preformed shapes may pick-and-place mounted into one or more layers of a multi-layer structure, for example mid build. In embodiments, Ferrites, for example, may be a material employed in relatively high frequency operation of magnetic devices, or in non-reciprocal microwave devices such as circulators, isolators, or phase shifters. In embodiments, for example where ferrite materials are employed, a sintering process may occur between approximately 900 degrees C. to 1300 degrees C. In embodiments, thin films may be produced and/or thicker materials with hulk properties may be incorporated using a process that fills holes and/or pockets in a resist, is bonded on and/or over a surface with mold, and/or is a laser-cut ferrite element. In embodiments, a relatively thin ferrite material may be used having a thickness substantially similar to the maximum thickness of a resist. In embodiments, bulk density properties may be attained. In embodiments, the serial nature of a pick-and-place operation, matching thicknesses between parts and/or films, and/or bubbles in a resist due to an imperfect fit may be accounted for. In embodiments, a pick-and-place operation may be readily automated.

Example Device Embodiments

According to embodiments, devices including a first material and a second material at the same layer of a multilayer structure may be fabricated. According to embodiments, devices including a multi-layer structure having components manufactured by one or more of an electrodeposition process, a transfer bonding process, a pick-and-place process, a dispensing process and/or a lamination process may be provided. In embodiments, a material, for example an active and/or passive electrical device, may be placed.

Devices manufactured in accordance with one aspect of embodiments may include structures such as inductors, transformers, springs, and/or coils, microactuators where the actuation distance and/or force is maximized, sensors such as magnetic field and/or inductive sensors, micro-engines and/or micro-generators, and or microfluidic devices. Devices manufactures may include close-to-true toroidal structures, and/or integrate them on and/or over a module, providing for approximately 10× better performance and/or 3-D integration with other devices to fabricate, for example, inductors, transformers, and/or electromagnetic actuators. In embodiments, conductive material, air, dielectrics and/or magnetic material may be provided in one or more layers, enabling for example working coils on and/or over magnetic coils. In embodiments, devices manufactured may include maximized force, throw and/or power. In embodiments, design versatility if maximized, for example providing metal crossovers suspended over other layers, to provide predetermined shapes desired.

In embodiments, devices manufactured may include microactuators which may be applied to a variety of fields, including speakers for hearing aids and relays to valves. In embodiments, devices manufactured may include microvalves which may be applied in energy application, for example fuel cell application, medical applications, in-vitro diagnostic applications, and/or chemical fields. In embodiments, devices manufactured may include microfluidic products which may no longer be limited to passive fluid control mechanisms such as capillary forces. In embodiments, such devices may be useful in fields which demand an ability to automate portable medical devices, micro fuel cells, and/or miniature reactors.

In embodiments, devices manufactured may include magnetic field sensors, for example for use in the automotive market for steering speed detection for ABS systems, and/or new electronic stability program (ESP). In embodiments, such sensors may be used in medical devices, for example, pacemakers and/or navigational systems. In embodiments, devices manufactured may include inductive sensors, where piezomagnetic materials may be used instead of or in addition to piezoelectric materials in applications such as pressure sensors and/or strain guages. In embodiments, performance for a given application may dictate the choice for material, for example for a magnetic solution. In embodiments, such parameters may include relatively higher forces over greater deflections, as is useful in actuators and/or relays.

According to embodiments, using multilayer structures in accordance with embodiments may relate to energy harvesting and/or power generation at a micro scale. In embodiments, integrating micro-engines with micro-generators for battery replacement applications may be provided. In embodiments, since hydrocarbon fuels may supply approximately 300 times more energy per unit weight than a NiCad battery and/or approximately 100 times more than a Li-ion battery, a micro-engine may have the potential to release the energy from the fuels and/or possibly replace batteries in portable devices.

In embodiments, relatively high Q's, high thermal conductivity, precision placement of coils and/or other components, and/or 3-D topology may be provided. In embodiments, architecture and/or design rules may be used to commercialize technology in accordance with one aspect of embodiments, for example by producing customized magnetic MEMS components and/or modules.

In embodiments, incorporation of ferrites may be used to make non-reciprocal microwave devices such as circulators, isolators, and phase shifters. In embodiments, active devices such as SiGe, GaN, Si, CMOS, InP and integrated or discrete devices may be embedded and may also be interconnected to other metal or dielectric structures or have electrical and thermal interconnects grown upon or to them using techniques taught in this art. Devices such a transistors, amplifiers, capacitors, resistors, lasers, detectors, mixers, signal processors, and control circuits, for example, may be pick and place integrated and/or embedded into a multi-layer build using the techniques described in this art.

It will be obvious and apparent to those skilled in the art that various modifications and variations can be made in the embodiments disclosed. Thus, it is intended that the disclosed embodiments cover the obvious and apparent modifications and variations, provided that they are within the scope of the appended claims and their equivalents.

What is claimed is:

1. A process comprising:
a. forming a seed layer on a substrate;
b. modifying the seed layer by at least one:
i. selectively applying a temporary patterned passivation layer; and
ii. selectively removing the seed layer;
c. selectively forming an image-wise mold layer over the substrate to expose at least one conductive area;
d. electrodepositing a first material on the exposed conductive area.

2. The process according to claim 1, wherein the substrate comprises an image-wise mold layer including at least one of conductive and insulative material.

3. The process according to claim 2, wherein the insulative material comprises at least one of photoresist and dielectric material.

4. The process according to claim 1, wherein selectively applying the temporary patterned passivation layer comprises depositing a layer of passivation material on the seed layer and patterning the passivation material to expose a portion of the seed layer.

5. The process according to claim 4, wherein the exposed conductive area is the exposed portion of the seed layer.

6. The process according to claim 1, wherein selectively applying the temporary patterned passivation layer comprises selectively placing passivation material on the seed layer to block a portion of the seed layer.

7. The process according to claim 5, wherein the passivation layer is substantially thinner relative to the image-wise mold layer.

8. The process according to claim 1, wherein selectively removing the seed layer exposes a non-conductive portion of the substrate.

9. The process according to claim 8, wherein the exposed conductive area is the remaining portion of the seed layer.

10. The process according to claim 1, comprising:
a. remove the temporary patterned passivation layer to provide another conducive area; and
f. forming a second material on the other conductive area.

11. The process according to claim 10, wherein at least one of the first material and the second material is formed by at least one of:
a. an electrodeposition process;
h. a transfer bonding process;
c. a dispensing process;
c. a lamination process.
d. a vapor deposition process
e. a screen printing process;
f. a squeegee process; and
g. a pick-and-place process.

12. The process according to claim 1, comprising planarizing at least the first material.

13. A multi-layer structure formed by the process according to claim 1.

14. A process comprising:
a. selectively applying a temporary patterned passivation layer on a conductive substrate;
c. selectively forming an image-wise mold layer over the substrate to expose at least one conductive area;
d. forming a first material on at least one of the exposed conductive areas;
e. removing the temporary patterned passivation layer to provide another conducive area; and
f. forming a second material on the other conductive area.

15. The process according to claim 14, wherein at least one of the first material and the second material is formed by at least one of:
a. an electrodeposition process;
b. a transfer bonding process;
c. a dispensing process;
c. a lamination process.
d. a vapor deposition process
e. a screen printing process;
f. a squeegee process; and
g. a pick-and-place process.

16. The process according to claim 14, comprising placing a blocking material on at least one of the at least one exposed conductive areas.

17. The process according to claim 16, wherein the blocking material comprises ceramic material.

18. A multi-layer structure formed by the process according to claim 14.

19. A process comprising:
a. forming a sacrificial image-wise mold layer on a substrate layer exposing at least one portion of the substrate layer;
b. selectively placing at least a first material in at least one of the at least one exposed portion of the substrate layer; and
c. forming at least a second material over the substrate layer; and
d. removing the sacrificial image-wise mold layer.

20. The process according to claim 19, wherein selectively placing the at least first material comprises a transfer bonding process, wherein:
a. at least the at least first material is affixed to a carrier substrate;
b. at least the at least first material is patterned;
c. at least the patterned first material is affixed to the substrate layer; and
d. the carrier substrate is released.

21. The process according to claim 19, wherein selectively placing the at least first material comprises a lamination process, wherein the first material is patterned at least one of before and after it is laminated to the substrate layer.

22. The process according to claim 19, wherein selectively placing the at least first material comprises a transfer bonding process, wherein the at least the first material is supported by a support lattice to suspend the first material before it is laminated and then the first material is laminated to the substrate layer.

23. The process of claim 19, wherein selectively placing the at least first material comprises a dispensing process, wherein the first material is selectively dispensed.

24. The process according to claim 19, wherein the first material and the second material are at least one of:
a. spaced apart from each other; and
b. adjacent each other.

25. The process according to claim 19, wherein the first material is one of a non-conductive and conductive material.

26. A multi-layer structure formed by the process according to claim 19.
